(19) United States
(12) Patent Application Publication
(10) Pub. No.: US 2021/0261329 A1
(43) Pub. Date: Aug. 26, 2021

(54) HINGE SYSTEM FOR THE LID OF A WASTE BIN

(71) Applicant: MGB RENTALS PTY LTD, Glenelg (AU)

(72) Inventors: Matthew James Norman Ramm, Black Forest (AU); Paul John Heitmann, Black Forest (AU); Michael John Brixton, Green Fields (AU)

(73) Assignee: MGB RENTALS PTY LTD, Glenelg (AU)

(21) Appl. No.: 17/059,888

(22) PCT Filed: May 28, 2019
(86) PCT No.: PCT/AU2019/050526

§ 371 Date: Nov. 30, 2020

(30) Foreign Application Priority Data
May 30, 2018 (AU) 2018901920

(51) Int. Cl. B65F 1/16; E05F 1/12; E05F 3/14; E05F 3/20; E05F 5/04

(52) U.S. Cl. CPC B65F 1/1623; B65F 1/1646; E05F 1/1207; E05F 3/14; E05F 3/20; E05F 5/04; E05Y 2900/602; E05F 2005/046; E05Y 2201/212; E05Y 2201/254; E05Y 2201/266; E05Y 2201/484; B65F 2001/1661

(57) ABSTRACT

5 A hinge system for a waste bin, the waste bin having a bin body with an open top and a lid for covering at least some of the open top, the system including a hinge assembly for hinging the lid to the bin body adjacent the open top, such that the lid is rotatable between a closed position covering at least part of the open top and an open position exposing the open top, and a damper assembly for connection to the bin body and the lid, the damper assembly having a damping mechanism configured for generating resistance to movement of the lid towards the closed position and substantially less resistance to movement of the lid towards the open position.

### TECHNICAL FIELD OF THE INVENTION

The present invention relates to the hinged lids of large-scale waste and refuse bins, such as those generally referred to in Australia as mobile garbage bins (or MGBs). Specifically, the invention relates to hinge systems for connecting the lids to the open tops of the bin bodies. Such bins usually have either two or four wheels, with volumes typically between 240 and 4,500 litres, with the smaller bins usually having a single lid and the larger bins having either a single lid or dual lids.

### BACKGROUND OF THE INVENTION

While smaller bins are able to utilise just a single, reasonably sized and weighted lid, larger bins tend to use a dual lid arrangement due to the typical weight of a single lid for such a large bin presenting opening and closing difficulties for a user. Where single lids are used for large bins, it has been found that the lids are often propped open for long periods of time, so as to avoid having to repeatedly raise and lower such a heavy lid, or that reasonably complex opening and closing mechanisms are required, adding cost to the bin/lid arrangement and introducing dangerous pinch points for the user. Also, these bins tend to be treated quite roughly in use, so the adoption of complex opening and closing mechanisms, particularly if they are exposed outside the bin, tends to leave those mechanisms readily subject to damage and the need for repair.

However, when two lids are used, in an attempt to lessen the weight and awkwardness of a large, single lid, and reduce the need for complex opening mechanisms, there tends to be a gap between the two lids that allows rainwater to enter the bin, adding weight to the interior of the bin and saturating the content of the bin. Since the cost of waste disposal is usually calculated by weight, waste companies are keen to minimise the ingress of water to these bins.

In light of these issues, it would be beneficial to develop a simple hinge system for a waste bin lid that allows for a single lid to cover the open top of the bin, particularly where it is a large waste bin. It would be advantageous if the lid could be opened with relatively little effort, and for the lid to remain open for a period of time without having to be propped open by a user.

Any reference herein to a patent document or other matter which is given as prior art is not to be taken as an admission that that document or matter was known or that the information it contains was part of the common general knowledge as at the priority date of any of the claims.

### SUMMARY OF THE INVENTION

The present invention provides a hinge system for a waste bin, the waste bin having a bin body with an open top and a lid for covering at least some of the open top, the system including:
a hinge assembly for hinging the lid to the bin body adjacent the open top, such that the lid is rotatable between a closed position at least partially covering the open top and an open position exposing the open top; and,
a damper assembly for connection to the bin body and the lid, the damper assembly having a damping mechanism configured for generating resistance to movement of the lid towards the closed position and substantially less resistance to movement of the lid towards the open position.

In a preferred form, the damping mechanism is configured to contain fluid and defines at least one flow path such that movement of the lid towards the open or the closed positions generates fluid flow along the at least one flow path, the fluid flow rate when the lid is moving towards the open position being substantially higher than the fluid flow rate when the lid is moving towards the closed position. Preferably the damping mechanism has two flow paths, one being a high flow rate path for the fluid flow generated by moving the lid towards the open position, and the other being a low flow rate path for the fluid flow generated by moving the lid to the closed position. In one form, the high flow rate path has a one way valve to allow fluid flow in one direction only.

Ideally, the damping mechanism has a fluid chamber for holding the fluid, and a vane configured for movement within the fluid chamber in response to moving the lid towards the open or closed positions, the high flow rate path and the low flow rate path being formed in the vane such that the flow direction through the high flow rate path is opposite that of the low flow rate path.

The damping mechanism may have one fluid flow path and a valve configured for a first fluid flow rate in one direction along the path and a second fluid flow rate for flow in an opposing direction, wherein the first fluid flow rate is substantially more than the second fluid flow rate. In one form, the valve is a flap valve with a flap that opens for the first fluid flow rate, and closes for the second fluid flow rate in the opposing direction, the flap having an aperture that allows the second fluid flow rate in the opposing direction. The aperture may be adjustable to vary the second fluid flow rate.

Preferably the damping mechanism has a pressure relief valve configured to open in response to fluid pressure in the fluid chamber exceeding a predetermined maximum.

The fluid chamber may have a volume divided by the vane configured to seal against an interior surface within the volume and sweep through the volume in response to hinged movement of the lid relative to the bin body, such that movement of the vane generates the fluid flow. Preferably, the pressure relief valve has a valve inlet, a valve outlet and valve member biased into sealed engagement with a valve seat such that the valve member is unseated against the bias in response to fluid pressure exceeding the predetermined maximum at the valve inlet. The valve inlet may be in fluid communication with a high pressure side of the vane when the lid is moving towards the closed position and the valve outlet is in fluid communication with a low pressure side of the vane when the lid is moving towards the closed position. Preferably, the bias urging the valve member into sealing engagement with the valve seat is adjustable to thereby vary the predetermined maximum fluid pressure.

In one form of the invention, the fluid chamber will contain liquid polymerised siloxane (silicone oil). In a preferred form, the liquid polymerised siloxane will be polydimethylsiloxane (PDMS).

The hinge assembly will ideally include a biasing mechanism for urging the lid towards an open position with a bias that is less than the weight of the lid. The hinge assembly may further include an elongate hinge axle with a longitudinal axis aligned with the hinge axis between the lid and the bin body, and the biasing mechanism may be at least one coil spring around the hinge axle with a coil axis aligned with the hinge axis wherein one end of the coil spring bears against the bin body and the other end bears against the lid, such that moving the lid towards the closed position twists the coil spring tighter to increase the bias applied to the lid.

Preferably the hinge assembly has at least one reinforcing element extending away from the hinge axis to increase structural rigidity of the lid. Optionally, the at least one reinforcing element is a plurality of strengthening bars extending beneath the lid transverse to the hinge axis.

The damper assembly may be mounted to the elongate hinge elements such that the vane rotates about the hinge axis when moving in the fluid chamber.

Another aspect of the present invention provides a waste bin for holding refuse, the waste bin including:
a bin body with an open top for receiving refuse;
a lid for covering at least some of the open top; and,
a hinge assembly for hinging the lid to the bin body adjacent the open top, the hinge assembly having a damper assembly for connection to the bin body and the lid, such that the lid is moveable from a closed position at least partially covering the open top to an open position exposing the open top;
wherein the damper assembly has a damping mechanism configured to generate resistance to movement of the lid towards the closed position.

Preferably the lid is sized to completely cover the open top and the hinge assembly further includes at least one reinforcing element extending from the hinge axis to increase structural rigidity of the lid. In a particularly preferred form, the lid is a single layer of injection moulded polymer.

### BRIEF DESCRIPTION OF THE DRAWINGS

Preferred embodiments of the present invention will now be described by way of example only, with reference to the accompanying figures. In which:

FIG. 1 is a perspective view of a waste bin according to the invention with the lid in the closed position;

FIG. 2 is a front perspective view of the waste bin of FIG. 1 with the lid raised to the open position;

FIG. 3 is a rear perspective view of the waste bin of FIG. 1 showing the damper assembly and coil springs of the hinge system;

FIG. 4 is a top perspective of the plastic bin lid shown in isolation;

FIG. 5 is a bottom perspective of the plastic bin lid shown in isolation;

FIG. 6 is a perspective of the hinge assembly shown in isolation;

FIG. 7 is an enlarged perspective of the damper assembly from the hinge assembly shown in FIG. 6;

FIG. 8 is a perspective of the elongate hinge bar and lid reinforcing bars from the hinge assembly shown in isolation;

FIG. 9 is an enlarged perspective of the damping mechanism shown in isolation;

FIG. 10 is a sectioned perspective of the damping mechanism shown in FIG. 9;

FIG. 11 is an end view of the damping mechanism shown in isolation;

FIG. 12 is a cross section through Section A-A shown in FIG. 11; and

FIG. 13 is a vertical cross section through the hinge axis of the waste bin.

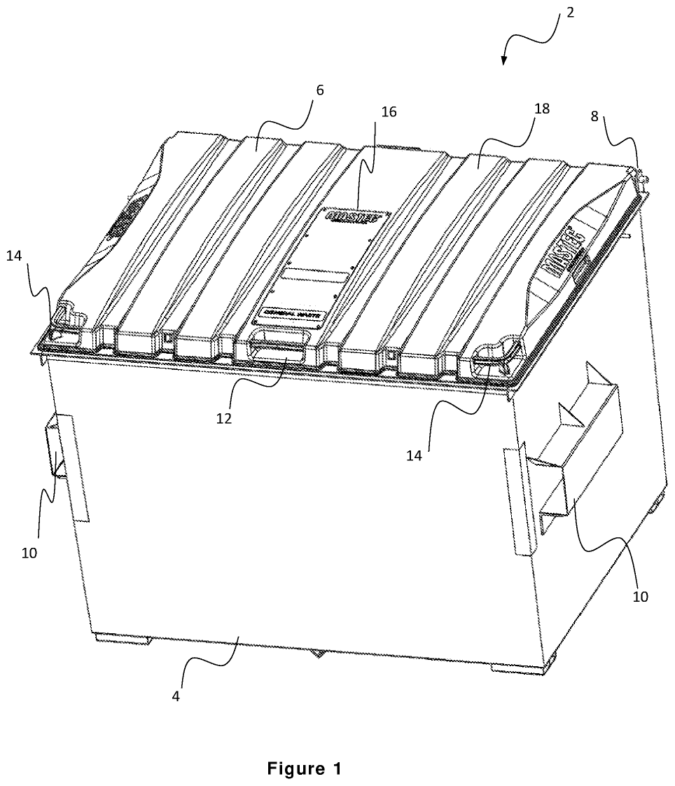

### DETAILED DESCRIPTION OF PREFERRED EMBODIMENT

Referring to the Figures, the waste bin 2 has a steel bin body 4 with a plastic lid 6 covering the open top 20. The lid 6 is hinged to the bin body 4 adjacent the open top 20 using a hinge system with a hinge assembly 8 that reinforces the lid 6, and a damping assembly 24 to hold the lid open long enough to deposit refuse before slowly closing.

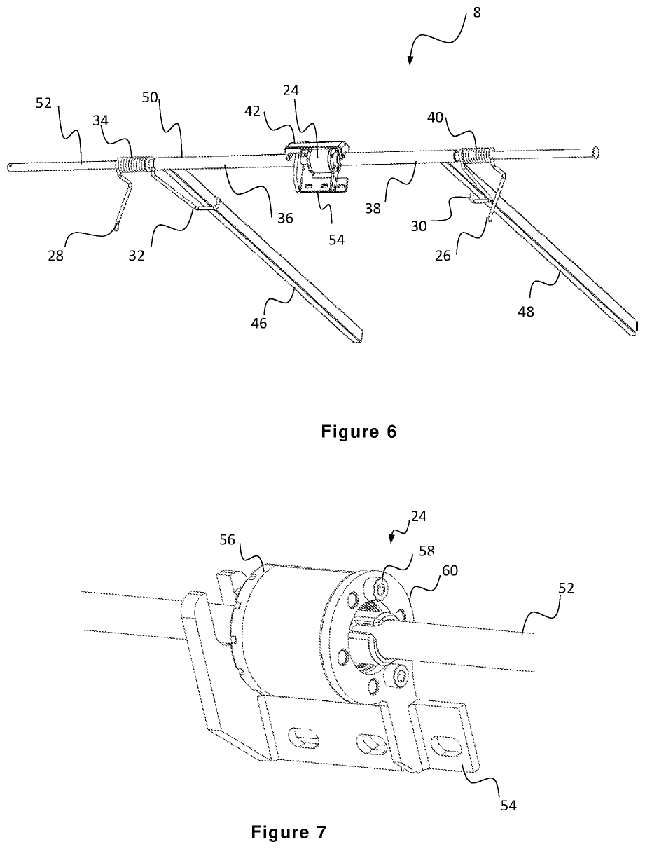

The hinge assembly 8 extends along the rear edge of the open top 20, while the front edge of the lid 6 has an integrally moulded centre handle 12 and front corner handles 14 on either side. The open top 20 of the bin body 4 is a relatively broad area for the lid to cover and integrally formed ribs 18 are provided to improve structural rigidity. Even with these ribs 18, the lids require additional stiffness and have traditionally been a dual layer polymer construction formed in a roto-molding process. Reducing this construction to a single layer, injection molded construction is lighter, and uses less polymer material for significant production cost benefits. Reinforcing bars 46 and 48 (see FIG. 6) provided by the hinge assembly 8 avoids excessive bending or flexing of the thinner lid 6 when lifted using the corner handles 14 or even the centre handle 12.

The waste bin 2 is of the front lift type, meaning garbage trucks lift the bin 2 from the front when emptying its contents. Two hydraulically driven front tynes on the garbage truck are inserted into the channels 10 on each side of the bin body 4. The bin is lifted up and over the cabin of the truck, then inverted so the contents fall under gravity into the back of the truck. To allow the contents of the bin to fall freely out of the bin body 4, the lid 6 needs to fall open quickly. Similarly, when users are lifting the lid 6 to deposit refuse, the weight of the lid or the hinge mechanism should not make the opening process overly strenuous or time consuming. However, having opened the lid 6, the user will often require two hands to then lift the load of refuse up and into the open top 20 of the bin body 4. To accommodate this, many prior art bins provide a strut at one or both sides of the lid to prop it open for the user.

Unfortunately, there is a tendency to forget about disengaging the struts and the lid remains propped open. Furthermore, keeping the lid open is often more convenient for the user when disposing of the next load of refuse. Unfortunately, the contents of the bin 2 are exposed to the elements while the lid is open and rain can saturate the refuse. This increases the weight of the refuse, which in turn increases the cost of waste disposal (which is typically calculated on the basis of weight).

As best shown in FIGS. 6 and 7, the hinge system uses a damper assembly 24 connected to the bin body 4 and the lid 6 to generate resistance to movement of the lid towards the closed position, but little or no resistance to movement of the lid towards the open position. In this way, the user may lift the lid 6 without undue effort and then has ample time to manually lift and deposit the refuse through the open top 20, as the lid 6 slowly falls back to the closed position under gravity. This removes the need to engage any side props or struts to hold the lid open, or subsequently disengage them after disposing of the refuse. With the lid 6 automatically closing (albeit slowly) under its own weight, the contents of the bin are not exposed to the weather for prolonged periods.

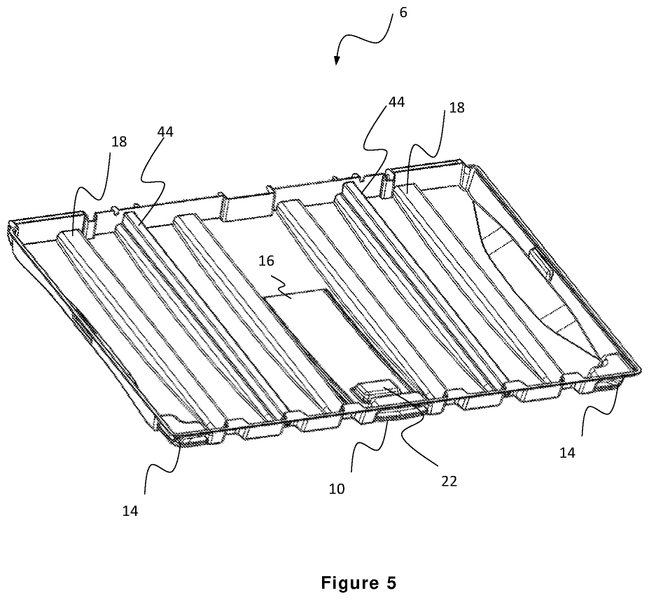

The hinge assembly 8 connects the damper assembly 24 to the lid 6 via a pair of lid reinforcing bars 46 and 48, inserted into integrally moulded channels 44 in the underside of the lid 6 (see FIG. 5). The lid reinforcing bars 46 and 48 are fixed to the hinge tube 50, which in turn is fixed to the elongate hinge axle 52. The longitudinal axis of the hinge axle 52 defines the hinge axis 64 for the lid (see FIG. 10).

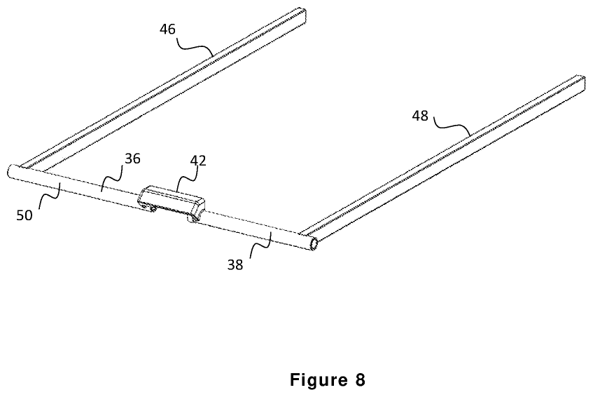

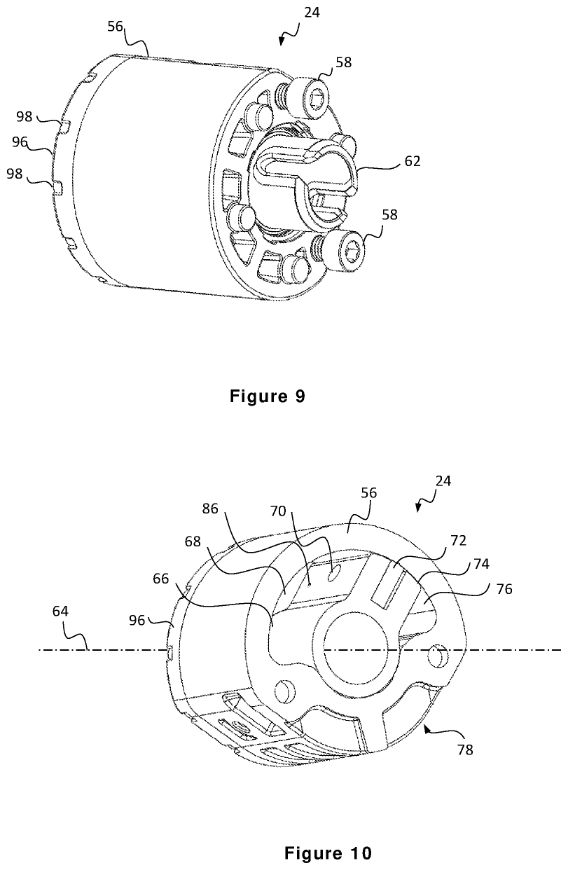

As best shown in FIG. 8, the hinge tube 50 is provided in two sections 36 and 38 connected by a travel stop surface 42. Referring back to FIG. 6, a damper assembly 24 sits beneath the travel stop surface 42 mounted on the hinge axle 52 and connects the inner ends of the tube sections 36 and 38. As best shown in FIGS. 7, 9 and 10, the inner ends of sections 36 and 38 are fixed to the central hub 62 of the damper assembly 24. The central hub 62 is integrally formed with a rotating vane 74. The rotating vane 74 moves within the fluid chamber 66 defined by the outer housing 56 of the damper assembly 24.

The fluid within the fluid chamber 66 may be any suitable liquid or gas. One particularly suitable fluid is liquid polymerised siloxane (silicone oil), such as polydimethylsiloxane (PDMS). This has a viscosity that does not vary greatly with temperature and therefore the damping response, and ultimately the closure rate of the lid is relatively constant despite changes in ambient temperature.

Lifting the lid 6 to the open position rotates the hinge tube 50, which in turn rotates the hinge axle 52. As a result, the internal vane 74 sweeps through the fluid chamber 66 with the rotation of the central hub 62. The silicone oil on one side 68 of the vane 74 is forced through a relatively large one-way valve 70 defining a flow path to the other side 76 of the vane 74. A much smaller one-way valve 86 remains closed against flow in that direction. A compressible vane seal 72 minimises leakage between the first side 68 and the second side 76 of the fluid chamber 66, but the flow rate through the larger valve 70 is such that it does not create and significant resistance to moving the lid to the open position. Conversely, as the lid falls shut, the silicon oil flows through the smaller one-way valve 86 in the other direction while the larger valve 70 closes. The lower flow rate slows the descent of the lid 6 allowing the user time to manually lift and deposit bags of refuse into the bin body 4.

In one alternative, the valve 70 is configured to allow a much higher flow rate of the silicone oil in one direction along the flow path relative to the flow rate in the opposite direction. The skilled worker will realise that this may be provided in many different forms but a simple implementation involves a flap valve with a carefully dimensioned aperture within the flap to govern the constricted flow rate of silicone oil through the valve as the lid 6 falls shut. Fluid flow in the ‘lid-opening’ direction simply opens the flap and there is little or no resistance to rotating the vane 74 within the fluid chamber 66 (when opening the lid). This variation of the damper mechanism 24 would not require the second relatively small one-way valve 86.

Skilled workers will also understand that such valves 70 are often provided with the ability for manual adjustment such that the aperture is changed to vary the constricted flow rate. Of course, this in turn adjusts the level of damping as the lid falls shut.

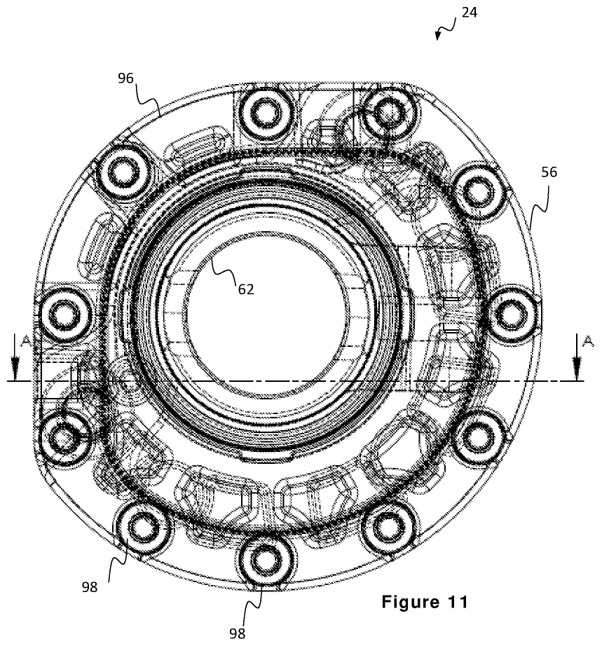

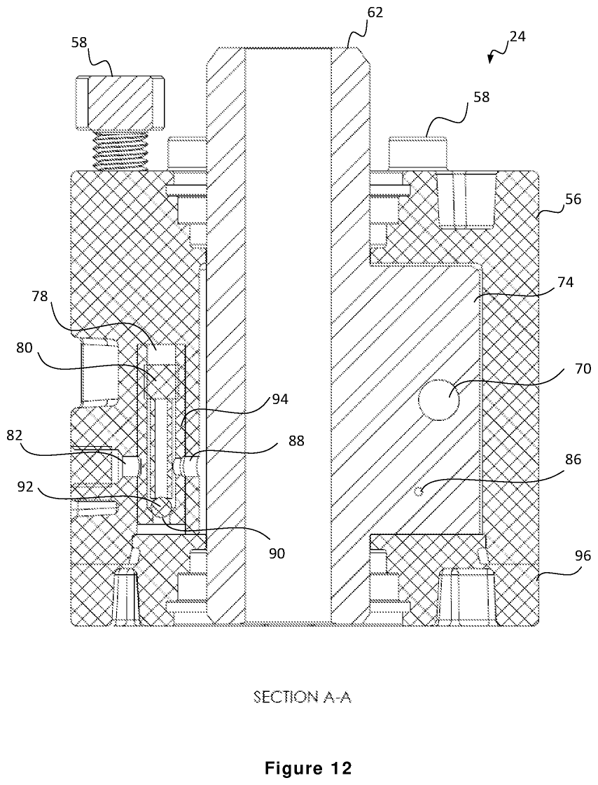

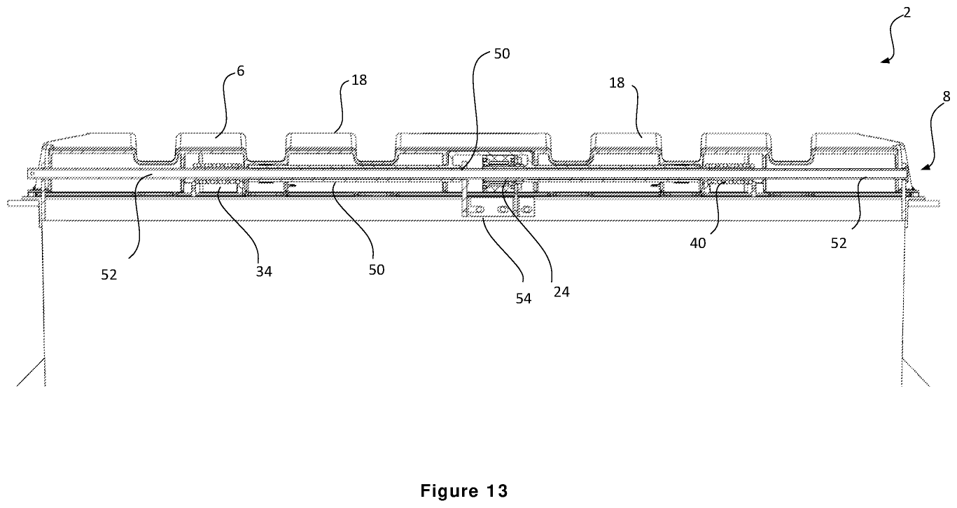

Referring to FIGS. 11 and 12, the damping mechanism 24 also incorporates a pressure relief valve 78 configured to open in response to the fluid pressure of silicone oil exceeding a predetermined maximum. This avoids damage to the damping mechanism if the lid is forced back to the closed position at a rate that generates pressure levels which could damage the valves 70 and/or 86, or compromise the fluid seal provided by the compression bolts 98 about the periphery of the end plate 96. The pressure relief valve 78 has a tubular valve body 94 defining a valve seat for sealing engagement with a valve member in the form of a ball 92. A biasing mechanism 80 in the form of a threaded boss engages a complementary internal thread within the bore of the valve body 94. The boss compresses a coil spring within the bore to urge the ball 92 against the valve seat. The valve inlet 90 is in fluid communication with the high pressure side of the vane 74 when the lid 6 is moving towards the closed position. The valve outlet 88 is in fluid communication with the low pressure side of the vane 74 when the lid 6 is closing. At the maximum pressure, the pressure difference across the ball 92 exceeds the bias of the spring to open the valve and allow oil from the high pressure side to vent to the low pressure side.

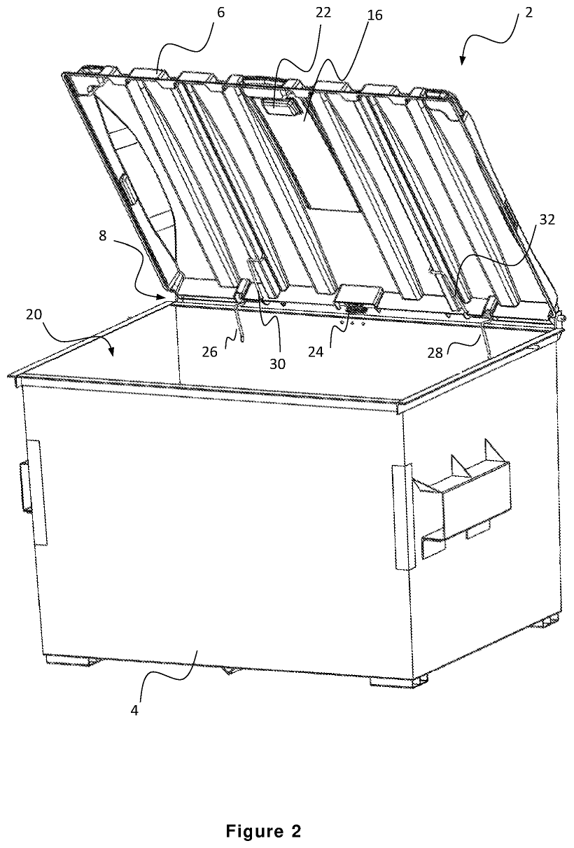

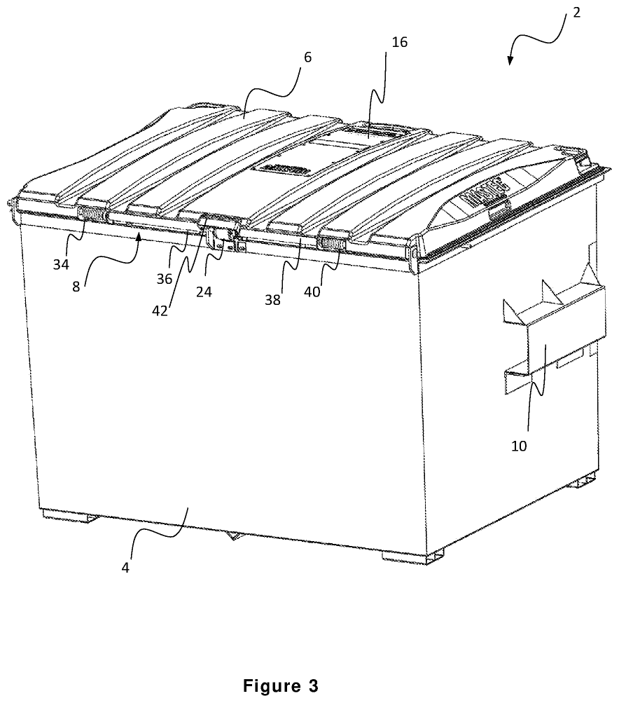

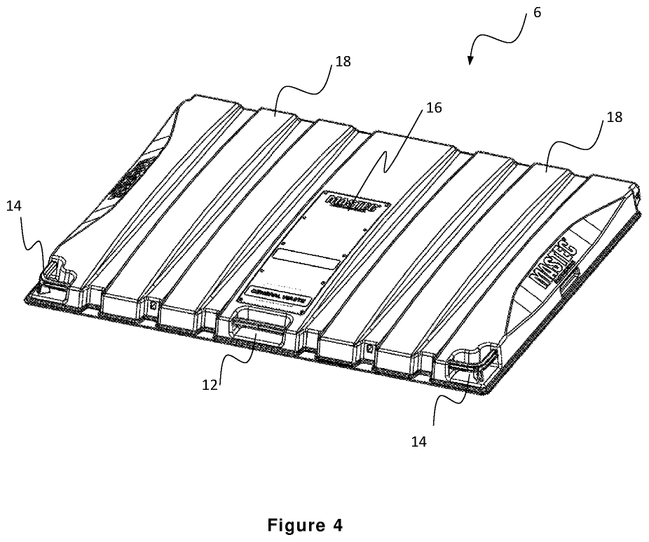

To assist the user, the hinge assembly 8 is provided with a pair of coil springs 34 and 40. The coil springs are twisted into a state of residual torque when the lid 6 is in the closed position. This provides lift assistance when opening the lid with one end of each of the springs 26 and 28 bearing against the bin body 4, while the opposing ends 30 and 32 bear on the reinforcing elements 48 and 46 respectively on the underside of the lid 6 (see FIG. 2).

The mounting plate 54 connecting the damping assembly 24 to the bin body 4 is configured to abut the travel stop surface 42 to limit to the angular travel of the lid. In this way, the lid 6 is restricted as to how far it can open such that it will always be at an angle where it will fall shut under gravity (assuming the bin 2 rests on a roughly horizontal surface). The mounting plate 54 also limits the opening travel of the lid 6 to prevent collision with the truck body while emptying the contents.

The lid 6 has a detachable central panel 16 coloured to indicate the type of refuse designated for the bin 2. Typically, bins are designated for different types of recyclable waste as well as general waste for landfill. Using a single, central panel 16 that is retrofitted to the lid 6, allows the lids to be produced in a single colour only, which is more efficient for manufacturing and warehousing of stock.

Beneath the central panel 16 is electronic circuitry 22 that can be used to track and/or identify the bin 2, or identify the type of waste stream designated to the bin and log the time and date of waste collections.

The invention has been described herein by way of example only. Skilled workers in this field will readily recognise many variations and modifications which do not depart from the spirit and scope of the broad inventive concept.

1. A hinge system for a waste bin, the waste bin having a bin body with an open top and a lid for covering at least some of the open top, the system including:
a hinge assembly for hinging the lid to the bin body adjacent the open top, such that the lid is rotatable between a closed position covering at least part of the open top and an open position exposing the open top; and
a damper assembly for connection to the bin body and the lid, the damper assembly having a damping mechanism configured for generating resistance to movement of the lid towards the closed position and substantially less resistance to movement of the lid towards the open position.

2. A hinge system according to claim 1, wherein the damping mechanism is configured to contain fluid and defines at least one flow path such that movement of the lid towards the open or the closed positions generates fluid flow along the at least one flow path, the fluid flow rate when the lid is moving towards the open position being substantially higher than the fluid flow rate when the lid is moving towards the closed position.

3. A hinge system according to claim 1, wherein the damping mechanism has two flow paths, one being a high flow rate path for the fluid flow generated by moving the lid towards the open position, and the other being a low flow rate path for the fluid flow generated by moving the lid to the closed position.

4. A hinge system according to claim 3, wherein the high flow rate path has a one way valve to allow fluid flow in one direction only.

5. A hinge system according to claim 3, wherein the damping mechanism has a fluid chamber for holding the fluid, and a vane configured for movement within the fluid chamber in response to moving the lid towards the open or closed positions, the high flow rate path and the low flow rate path being formed in the vane such that the flow direction through the high flow rate path is opposite that of the low flow rate path.

6. A hinge system according to claim 1, wherein the damping mechanism has one fluid flow path and a valve configured for a first fluid flow rate in one direction along the path and a second fluid flow rate for flow in an opposing direction, wherein the first fluid flow rate is substantially more than the second fluid flow rate.

7. A hinge system according to claim 6, wherein the valve is a flap valve with a flap that opens for the first fluid flow rate, and closes for the second fluid flow rate in the opposing direction, the flap having an aperture that allows the second fluid flow rate in the opposing direction.

8. A hinge system according to claim 7, wherein the aperture is adjustable to vary the second fluid flow rate.

9. A hinge system according to claim 5, wherein the damping mechanism has a pressure relief valve configured to open in response to fluid pressure in the fluid chamber exceeding a predetermined maximum.

10. A hinge system according to claim 9, wherein the fluid chamber has a volume divided by the vane configured to seal against an interior surface within the volume and sweep through the volume in response to hinged movement of the lid relative to the bin body, such that movement of the vane generates the fluid flow.

11. A hinge system according to claim 10, wherein the pressure relief valve has a valve inlet, a valve outlet and valve member biased into sealed engagement with a valve seat such that the valve member is unseated against the bias in response to fluid pressure exceeding the predetermined maximum at the valve inlet.

12. A hinge system according to claim 11, wherein the valve inlet is in fluid communication with a high pressure side of the vane when the lid is moving towards the closed position and the valve outlet is in fluid communication with a low pressure side of the vane when the lid is moving towards the closed position.

13. A hinge system according to claim 12, wherein he bias urging the valve member into sealing engagement with the valve seat is adjustable to thereby vary the predetermined maximum fluid pressure.

14. A hinge system according to claim 5 wherein the fluid chamber contains liquid polymerised siloxane (silicone oil).

15. A hinge system according to claim 14, wherein the liquid polymerised siloxane is polydimethylsiloxane (PDMS).

16. A hinge system according to claim 1, wherein the hinge assembly has a biasing mechanism for urging the lid towards an open position with a bias that is less than the weight of the lid.

17. A hinge system according to claim 16, wherein the hinge assembly further includes an elongate hinge axle with a longitudinal axis aligned with the hinge axis between the lid and the bin body, and the biasing mechanism is at least one coil spring around the hinge axle with a coil axis aligned with the hinge axis wherein one end of the coil spring bears against the bin body and the other end bears against the lid, such that moving the lid towards the closed position twists the coil spring tighter to increase the bias applied to the lid

18. A hinge system according to claim 1, wherein the hinge assembly has at least one reinforcing element extending away from the hinge axis to increase structural rigidity of the lid.

19. A hinge system according to claim 18, wherein the at least one reinforcing element is a plurality of strengthening bars extending beneath the lid transverse to the hinge axis.

20. A hinge system according to claim 19, wherein the damper assembly mounts to the elongate hinge elements such that the vane rotates about the hinge axis when moving in the fluid chamber.

21. A waste bin for holding refuse, the waste bin comprising:
a bin body with an open top for receiving refuse;
a lid for covering at least some of the open top; and
a hinge assembly for hinging the lid to the bin body adjacent the open top, the hinge assembly having a damper assembly for connection to the bin body and the lid, such that the lid is moveable from a closed position at least partially covering the open top to an open position exposing the open top;
wherein the damper assembly has a damping mechanism configured to generate resistance to movement of the lid towards the closed position.

22. A waste bin according to claim 21, wherein the lid is sized to completely cover the open top and the hinge assembly further includes at least one reinforcing element extending from the hinge axis to increase structural rigidity of the lid.

23. A waste bin according to claim 21 or claim 22, wherein the lid is a single layer of injection moulded polymer.

24. A waste bin according to claim 21, wherein the damping mechanism is configured to contain fluid and defines at least one flow path such that movement of the lid towards the open or the closed positions generates fluid flow along the at least one flow path, the fluid flow rate when the lid is moving towards the open position being substantially higher than the fluid flow rate when the lid is moving towards the closed position.

25. A waste bin according to claim 24, wherein the damping mechanism has two flow paths, one being a high flow rate path for the fluid flow generated by moving the lid towards the open position, and the other being a low flow rate path for the fluid flow generated by moving the lid to the closed position.

26. A waste bin according to claim 25, wherein the high flow rate path and the low flow rate path each have a one way valve to allow fluid flow in one direction only.

27. A waste bin according to claim 26, wherein the damping mechanism has a fluid chamber for holding the fluid, and a vane configured for movement within the fluid chamber in response to moving the lid towards the open or closed positions, the high flow rate path and the low flow rate path being formed in the vane such that the flow direction through the high flow rate path is opposite that of the low flow rate path.

28. A waste bin according to claim 21 wherein the damping mechanism has one fluid flow path and a valve configured for a first fluid flow rate in one direction along the path and a second fluid flow rate for flow in an opposing direction, wherein the first fluid flow rate is substantially more than the second fluid flow rate.

29. A waste bin according to claim 21 wherein the damping mechanism has a pressure relief valve configured to open in response to fluid pressure in the fluid chamber exceeding a predetermined maximum.

30. A waste bin according to claim 27, wherein the fluid chamber has a volume divided by the vane configured to seal against an interior surface within the volume and sweep through the volume in response to hinged movement of the lid relative to the bin body, such that movement of the vane generates the fluid flow.

31. A waste bin according to claim 27, wherein the fluid chamber contains liquid polymerised siloxane (silicone oil).

32. A waste bin according to claim 31, wherein the liquid polymerised siloxane is polydimethylsiloxane (PDMS).

33. A waste bin according to claim 21, wherein the hinge assembly has a biasing mechanism for urging the lid towards the open position with a bias that is less than the weight of the lid.

34. A waste bin according to claim 33, wherein the hinge assembly further includes an elongate hinge axle with a longitudinal axis aligned with the hinge axis between the lid and the bin body, and the biasing mechanism is at least one coil spring around the hinge axle with a coil axis aligned with the hinge axis wherein one end of the coil spring bears against the bin body and the other end bears against the lid, such that moving the lid towards the closed position twists the coil spring tighter to increase the bias applied to the lid.

35. A waste bin according to claim 34, wherein the vane within the fluid chamber rotates together with the hinge axle.

36. A waste bin according to claim 34 wherein the hinge axle has an abutment surface which limits rotation of the lid away from the open top such that the lid always falls towards the closed position under gravity when the waste bin is on a substantially horizontal support surface.
